(19) United States
(12) Patent Application Publication
(10) Pub. No.: US 2020/0033601 A1
(43) Pub. Date: Jan. 30, 2020

(54) HAPTIC SKULL CAP

(71) Applicant: Facebook Technologies, LLC, Menlo Park, CA (US)

(72) Inventors: Lesley Ribble Magrath, Seattle, WA (US); Adam Hewko, Kirkland, WA (US); Robin Michael Miller, Redmond, WA (US); Jared I. Drinkwater, Black Diamond, WA (US); Michael Roy Bland, Seattle, WA (US); Shane Michael Ellis, Bellevue, WA (US); Paul Michael Zornes, Kirkland, WA (US); Bradley Morris Johnson, Edmonds, WA (US); John R. Dombey, Ravensdale, WA (US); Khaled Boulos, Seattle, WA (US); Jason Higgins, Seattle, WA (US)

(21) Appl. No.: 15/823,522

(22) Filed: Nov. 27, 2017

(51) Int. Cl. G02B 27/01; G06F 3/01; G06F 1/16

(52) U.S. Cl. CPC G02B 27/017; G06F 3/016; G06F 1/163; G06F 3/011

(57) ABSTRACT

A haptic skull cap provides different types of haptic feedback to a user, which can be advantageous for providing a more immersive virtual reality experience. The haptic skull cap includes a fabric cap worn by a user. Physically attached to the fabric cap is a linear actuator that provides a focal impact to a user's forehead. Additionally, vibrational motors are physically attached to the fabric cap, where each vibration motor provides vibrational feedback to a different location of the user's head. The haptic skull cap can be worn by a user in conjunction with a head mounted display. Therefore, each type of haptic feedback provided by the haptic skull cap can be synchronized with the visual data stream provided by the head mounted display which further enhances the overall virtual reality experience for a user.

### BACKGROUND

This disclosure generally relates to wearable head gear, and more specifically to a head cap that provides haptic feedback to an individual wearing the head cap.

A user wears a head mounted display to experience virtual reality (VR). A VR experience includes the provision of visual sensory feedback to the user. Therefore, the user wearing the head mounted display can be visually transported to encounter various scenarios. The visual sensory feedback is designed to ensure that the user truly feels like he/she is in the virtual location.

In addition to the head mounted display, some conventional systems can employ additional hardware to further immerse the user in the VR experience. For example, a user can also wear VR headsets that can provide audio feedback to a user in conjunction with the visual sensory feedback. Therefore, the combination of a head mounted display and headset can offer a more immersive VR experience to a user. However, although these conventional VR systems can provide a satisfactory VR experience to a user, there is still room to improve conventional VR systems to further immerse the user in the VR experience.

### SUMMARY

Embodiments relate to a haptic skull cap worn by a user that provides haptic feedback to the user. The skull cap is worn by the user in conjunction with a head mounted display to provide an immersive VR experience. In various embodiments, when worn by an individual the skull cap provides multiple types of haptic feedback. As an example, a first type of haptic feedback, such as a focal impact, may be provided through a linear actuator. The haptic skull cap can further provide, to the user, a second type of haptic feedback through each of one or more vibrational motors that are positioned at different locations on the internal surface of the skull cap. Therefore, the user can be provided vibrational haptic feedback through these vibrational motors.

### BRIEF DESCRIPTION OF THE DRAWINGS

FIG. 1 is a perspective view of a head mounted display system that includes a haptic skull cap, in accordance with an embodiment.

FIG. 2 is a bottom perspective view of the head mounted display system that includes the haptic skull cap, in accordance with an embodiment.

FIG. 3A is a cross-section of a haptic feedback actuator of the haptic skull cap in a rest state, in accordance with an embodiment.

FIG. 3B is a cross-section of a haptic feedback actuator of the haptic skull cap in an actuated state, in accordance with an embodiment.

FIG. 4 is a second haptic feedback actuator of the haptic skull cap, in accordance with an embodiment.

FIG. 5 is a flow process for providing haptic feedback using a haptic skull cap, in accordance with an embodiment.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. For example, a letter after a reference numeral, such as “wire 180A,” indicates that the text refers specifically to the element having that particular reference numeral. A reference numeral in the text without a following letter, such as “wire 180,” refers to any or all of the elements in the figures bearing that reference numeral (e.g. “wire 180” in the text refers to reference numerals “wire 180A” and/or “wire 180B” in the figures).

Embodiments relate to a head mounted display system that includes a skull cap with haptic feedback actuators. The head mounted display system is worn on a user's head. Each haptic feedback actuator provides a type of haptic feedback to the user. More than one type of haptic feedback actuator may be provided on the skull cap to provide different types of haptic feedback. The haptic feedback, in conjunction with visual and/or auditory sensory feedback, can provide a user with a more immersive VR experience.

### Head Mounted Display System

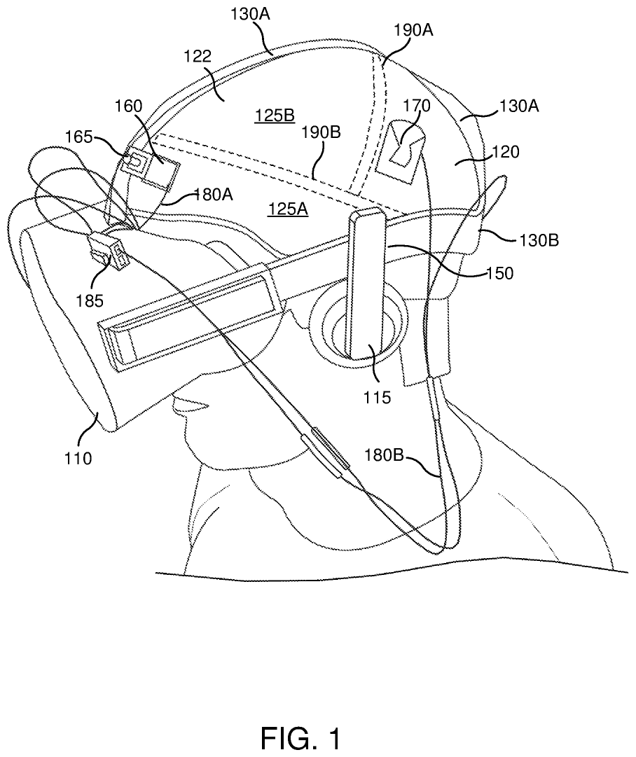

FIG. 1 is a perspective view of a head mounted display system that includes a haptic skull cap, in accordance with a first embodiment. In various embodiments, the head mounted display system includes a head mounted display 110 and a haptic skull cap 120. In various embodiments, the head mounted display system further includes other components such as headphones 115.

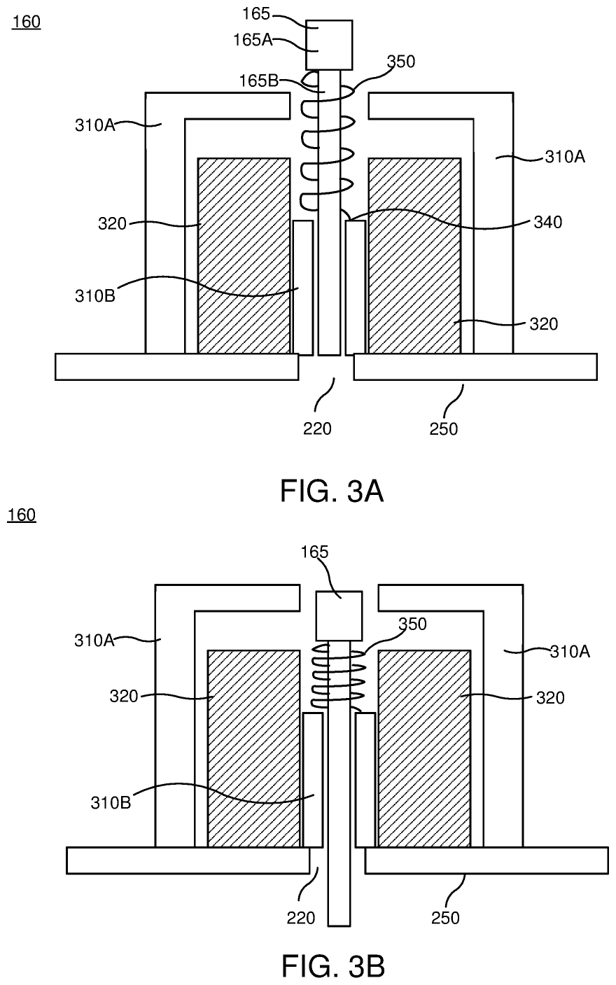

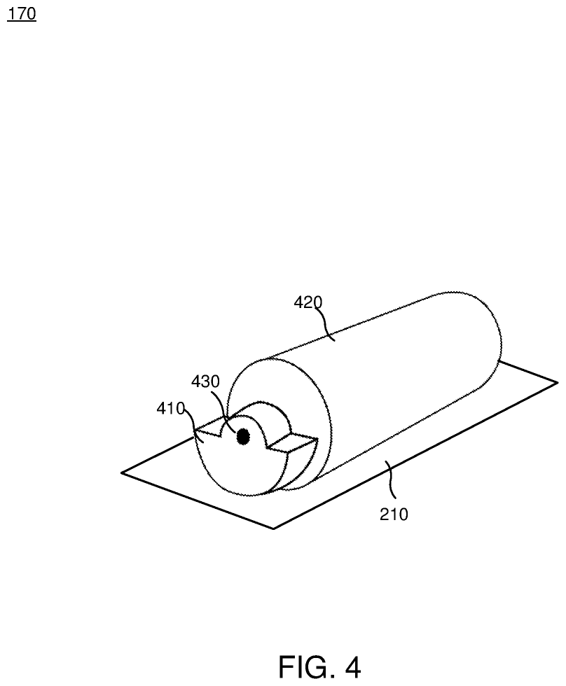

As shown in FIG. 1, the haptic skull cap 120 is worn by a user and is in contact with the user's head. The haptic skull cap 120 includes a fabric cap 122 worn by the user as well as one or more haptic feedback actuators 160 and 170 that are physically attached at various locations of the fabric cap 122. Each haptic feedback actuator 160 and 170 provides haptic feedback to the user through the fabric cap 122 of the haptic skull cap 120. Specifically, the fabric cap 122 includes a first haptic feedback actuator 160, which can be embodied as a linear actuator 160 that controls a plunger 165, as described below with reference to FIGS. 3A and 3B. When the linear actuator 160 is actuated, the plunger 165 translationally displaces and impacts the user's head. Additionally, the fabric cap 122 may include a second haptic feedback actuator 170, which can be embodied as a vibrational motor 170 described below with reference to FIG. 4. The second haptic feedback actuator 170 may also hereafter be referred to as a haptic feedback vibrator.

Each of haptic feedback actuators 160 and 170 is physically attached to the fabric cap 122. In one embodiment, each haptic feedback actuator 160 and 170 is adhered to the fabric cap 122 through an adhesive (e.g., tape, glue, VELCRO), buttons, fasteners, and the like. In another embodiment, each haptic feedback actuator 160 and 170 is stitched onto the fabric cap 122. For example, each haptic feedback actuator 160 and 170 are sewn inside fabric pockets of the skull cap.

Each of haptic feedback actuators 160 and 170 provides haptic feedback to the user's head. Specifically, each haptic feedback actuator 160 and 170 provides haptic feedback to a particular location of the user's head that is located in close proximity to the haptic feedback actuator 160 and 170. For example, as shown in FIG. 1, the first haptic feedback actuator 160 provides haptic feedback to the user's forehead, which is located directly underneath the first haptic feedback actuator 160. As another example, the second haptic feedback actuator 170 is located on the side of the fabric cap 122. Therefore, the second haptic feedback actuator 170 provides haptic feedback to the side of the user's head that is located directly underneath the second haptic feedback actuator 170.

In other embodiments, the location of the first haptic feedback actuator 160 and second haptic feedback actuator 170 on the fabric cap 122 may differ from the embodiment shown in FIG. 1. In some embodiments, the haptic skull cap 120 can include multiple first haptic feedback actuators 160 that are each physically coupled to the fabric cap 122 at a different location. In various embodiments, the haptic skull cap 120 can include multiple second haptic feedback actuators 170 that are each physically coupled to the fabric cap 122 at a different location.

In various embodiments, the second haptic feedback actuator 170 can be located in a different elevational plane in comparison to the first haptic feedback actuator 160. For example, as shown in FIG. 1, the second haptic feedback actuator 170 is at a higher elevation than the first haptic feedback actuator 160.

In particular embodiments, the haptic skull cap 120 includes one of a first haptic feedback actuator 160 and three of the second haptic feedback actuators 170. The first haptic feedback actuator 160 is located at the front of the fabric cap 122 to provide haptic feedback to the user's forehead. In one embodiment, the three second haptic feedback actuators 170 can be differently positioned on the fabric cap 122 such that the haptic skull cap 120 can provide haptic feedback to distributed locations of the user's head. For example, second haptic feedback actuators 170 can be located on the left, front right, and rear sides of the fabric cap 122. In some embodiments, the three second haptic feedback actuators 170 can be equidistantly positioned around the fabric cap 122.

The fabric cap 122 can be composed of a material such as felt, wool, leather, mesh, cotton, or polyester. In various embodiments, the fabric cap 122 includes a stretchable material such as spandex, elastane, or polyurethane. In such embodiments, the fabric cap 122 is stretchable. A stretchable fabric cap 122 can be tautly worn by the user. In some scenarios, a stretchable fabric cap 122 may be preferred in comparison to a non-stretchable cap. Specifically, as the stretchable fabric cap 122 is tautly worn by a user, the first haptic feedback actuator 160 and second haptic feedback actuator 170 that are physically attached to the stretchable fabric cap 122 can more efficiently provide haptic feedback to the user as each feedback actuator 160 and 170 is in contact with or in close proximity to the user's head.

In various embodiments, the fabric cap 122 can be fabricated from different pieces of material. As shown in FIG. 1, the fabric cap 122 may include vertical stitches 190A and horizontal stitches 190B that stitch together different pieces of the fabric cap 122. As an example, the horizontal stitches 190B delineate a top portion 125B of the fabric cap 122 from a bottom portion 125A of the fabric cap 122. In various embodiments, the bottom portion 125A of the fabric cap 122 may have a higher elasticity in comparison to the top portion 125B of the fabric cap 122. The increased elasticity of the bottom portion 125A of the fabric cap 122 facilitates the donning of the fabric cap 122.

Referring now to the head mounted display 110, it includes a head strap 130 that stabilizes the head mounted display 110 when worn by a user. A first portion 130A of the head strap 130 extends from the head mounted display 110. When the head mounted display 110 is worn by the user, the first portion 130A of the head strap 130 extends along the sagittal plane of the user. Additionally, a second portion 130B of the head strap 130 is connected to the first portion 130A of the head strap and couples with the head mounted display 110. When the head mounted display 110 is worn by the user, the second portion 130B of the head strap 130 wraps around one side of the user's head. Although FIG. 1 depicts a perspective view including a second portion 130B of the head strap 130 that wraps around the left side of the user's head, one can appreciate that a similar second portion 130B of the head strap 130 can wrap around the right side of the user's head. Generally, the first portion 130A and second portion 130B of the head strap 130 are externally positioned relative to the fabric cap 122. This enables the fabric cap 122 to be in contact with or in close proximity to the user's head.

Referring now to the headphones 115, it provides auditory feedback to the user. Although FIG. 1 and the subsequent description is in reference to a single headphone worn on the left ear of the user, one can appreciate that a second headphone 115 can also be worn on the right ear of the user. As shown in FIG. 1, the headphone 115 can be coupled to the second portion 130B of the head strap 130 at coupling point 150. The coupling point 150 can employ one or more of adhesives (e.g., tape, glue, VELCRO), buttons, fasteners, and the like to couple the headphone 115 to the second portion 130B of the head strap 130.

### Communication Between Elements of the Head Mounted Display System

Generally, the head mounted display 110 is communicatively coupled to components of the haptic skull cap 120 and the headphones 115. The head mounted display 110 can include a memory storage and one or more processors for communicating with the haptic skull cap 120 and the headphones 115. In the embodiment shown in FIG. 1, the head mounted display 110 is communicatively coupled to the haptic feedback actuators 160 and 170 of the haptic skull cap 120 through one or more wires 180A and 180B. Specifically, the head mounted display 110 is communicatively coupled to the first haptic feedback actuator 160 through wire 180A and is further communicatively coupled to each of the second haptic feedback actuators 170 through wire 180B. In various embodiments, the head mounted display system can further include wire organizers such as a wire harness 185 that can control for the number of wires that enable the communication between the head mounted display 110 and the feedback actuators 160 and 170 of the haptic skull cap 120. Although not explicitly shown in FIG. 1, the head mounted display 110 may also be communicatively coupled to the headphones 115 through wires.

Although FIG. 1 depicts the communicative coupling of the head mounted display 110 with the haptic skull cap 120 and the headphones 115 through wires 180A, 180B, in other embodiments, the head mounted display 110 is communicatively coupled to the headphones 115 and the haptic skull cap 120 through one or more non-wired means. For example, each of the head mounted display 110, headphones 115, and feedback actuators 160 and 170 of the haptic skull cap 120 can include hardware that enables non-wired communication. Such non-wired communication methods can be one of Bluetooth, WiFi, Near Field Communication (NFC), or radio-frequency identification (RFID).

Altogether, communicatively coupling the head mounted display 110 with the headphones 115 and haptic skull cap 120 enables a fully immersive virtual reality experience through the combination of visual, auditory, and haptic feedback. For example, the head mounted display 110 communicates with both the actuators 160 and 170 of the haptic skull cap 120 and the headphones 115 such that the visual, auditory, and haptic feedback provided to the user are synchronized.

In one embodiment, the head mounted display 110 provides a stream of visual data to a user while each haptic feedback actuator 160 and 170 of the haptic skull cap 120 provides intermittent haptic feedback to a user. In various embodiments, each of the haptic feedback actuators 160 and 170 provides the haptic feedback in response to a signal sent by the head mounted display 110. As an example, one or both of the feedback actuators 160 and 170 of the haptic skull cap 120 can provide haptic feedback in response to a signal from the head mounted display 110 that corresponds to a trigger event. As used hereafter, a trigger event refers to an event detected by the head mounted display 110 in the virtual reality experience.

In various embodiments, trigger events are stored by the head mounted display 110 in a memory storage of the head mounted display 110. If a trigger event in the virtual reality experience occurs, a processor of the head mounted display 110 sends a signal to one or both of the haptic feedback actuators 160 or 170. In one embodiment, a trigger event stored by the head mounted display 110 can be specific for a particular haptic feedback actuator 160 or 170. For example, the head mounted display 110 stores a relationship between the trigger event and the specific haptic feedback actuator 160 or 170. When the trigger event occurs, the head mounted display 110 sends a signal to the corresponding haptic feedback actuator 160 or 170 identified in the stored relationship.

To provide context in relation to a trigger event, a user of the head mounted display system can be playing a virtual reality game, such as a first person shooter game. The head mounted display 110 provides a continuous stream of visual data to the user and can detect a trigger event. An example trigger event stored by the head mounted display 110 may be that the user's character in the virtual reality game is shot. In response to the trigger event being satisfied, the head mounted display 110 provides a signal to the first haptic feedback actuator 160 that causes the first haptic feedback actuator 160 to provide a haptic feedback. In this example, the plunger 165 of the first haptic feedback actuator 160 can actuate and impact the user's forehead, signaling to the user that the user's character in the virtual reality game was shot.

To provide another example of a trigger event that is specific for a second haptic feedback actuator 170, the example trigger event stored by the head mounted display 110 may be a shot that narrowly missed the user's character on the left side. Therefore, the head mounted display 110 can send a signal to the second haptic feedback actuator 170 that is located on the left side of the fabric cap 122. The second haptic feedback actuator 170 located on the left side of the fabric cap 122 provides a haptic feedback to the user, signaling to the user of a narrow miss on the left side of the user's character.

Each signal provided by the head mounted display 110 to the first haptic feedback actuator 160 or the second haptic feedback actuator 170 causes the first haptic feedback actuator 160 or the second haptic feedback actuator 170, respectively, to provide a haptic feedback. In various embodiments, the signal can be one of a direct current or alternating current signal. In one embodiment, the signal provided by the head mounted display 110 can be a binary high or low signal that causes the actuation or inactivation of either the first haptic feedback actuator 160 or the second haptic feedback actuator 170. In various embodiments, the signal can cause the first haptic feedback actuator 160 or second haptic feedback actuator 170 to provide varying levels of haptic feedback. As one example, the signal may have a particular amplitude that causes the plunger 165 of the first haptic feedback actuator 160 to travel at a particular speed, thereby causing a corresponding level of impact on the user's head. As another example, the signal causes the second haptic feedback actuator 170 to vibrate at a particular frequency, at a particular vibrational amplitude, or for a particular duration.

### Haptic Feedback Actuators

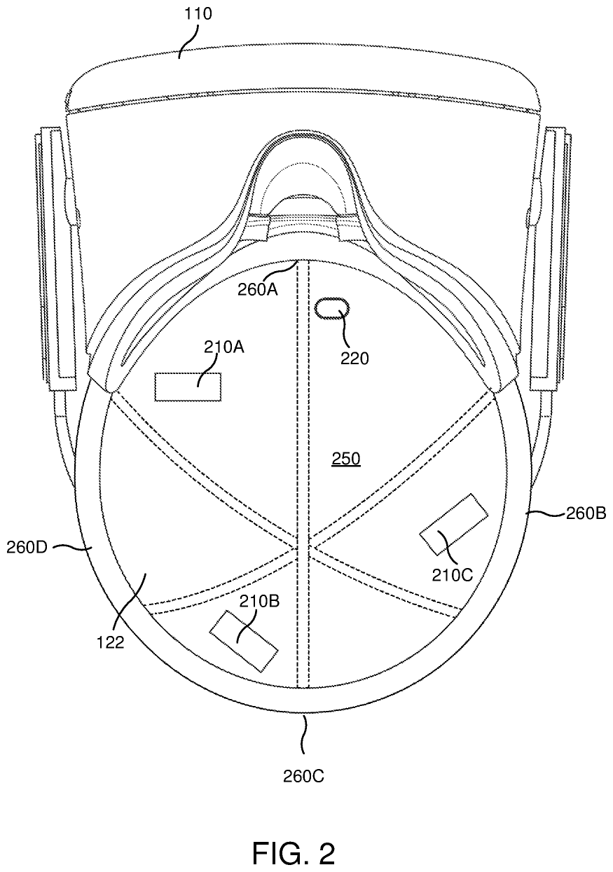

FIG. 2 is a bottom perspective view of the head mounted display system that includes the haptic skull cap 120, in accordance with an embodiment. In particular, FIG. 2 depicts a view of the internal surface 250 of the fabric cap 122. When the haptic skull cap 120 is worn by a user, the internal surface 250 of the fabric cap 122 is contact with the user's head. The internal surface 250 includes one or more covers 210 and an opening 220.

Referring first to the covers 210, each cover 210 can be composed of a fabric, plastic, polymer. In some embodiments, each cover 210 is fabricated from a material similar to that of the fabric cap such as felt, wool, leather, mesh, cotton, polyester, spandex, elastane, or polyurethane. Each cover 210 can sit flush with the internal surface 250 of the fabric cap 122. In various embodiments, each of the one or more covers 210 corresponds to a second haptic feedback actuator 170. Therefore, the second haptic feedback actuator 170 can provide a vibrational haptic feedback to the user's head through the corresponding cover 210. In various embodiments, the opening 220 corresponds to a first haptic feedback actuator 160. Specifically, the first haptic feedback actuator 160 provides a haptic feedback (e.g., a focal impact) to the user's head through the opening 220.

As shown in FIG. 2, each of the covers 210A through 210C (hereinafter collectively referred to as “cover 210”) can be differently located on the internal surface 250 of the fabric cap 122. As one example, each cover 210 can be located on a different side of the fabric cap 122. Each side of the fabric cap 122 is hereafter referred to from the perspective of the user wearing the haptic skull cap 120. For example, a first cover 210A (corresponding to one of three second haptic feedback actuators 170) is located on the front right side 260A of the fabric cap 122, a second cover 210B is located on the rear side 260C of the fabric cap 122, and a third cover 210C is located on the left side 260B of the fabric cap 122. In various embodiments, the location of each of the covers 210 and the opening 220 can be differently positioned (in comparison to the embodiment shown in FIG. 2) on the internal surface 250 of the fabric cap 122 depending on where the corresponding first haptic feedback actuator 160 and second haptic feedback actuators 170 are located.

Referring now to FIG. 3A, it depicts a cross-section of an example first haptic feedback actuator 160 of the haptic skull cap 120 in a rest state, in accordance with an embodiment. Further reference will be made to FIG. 3B which depicts a cross-section of an example first haptic feedback actuator 160 of the haptic skull cap 120 in an actuated state, in accordance with an embodiment. As used hereafter, the rest state of the first haptic feedback actuator 160, as shown in FIG. 3A, refers to the default configuration of the first haptic feedback actuator 160 at rest. Additionally, the actuated state of the first haptic feedback actuator 160, as shown in FIG. 3B, refers to an actuated configuration when the first haptic feedback actuator 160 receives a signal from the head mounted display 110.

In the embodiments shown in FIGS. 3A and 3B, the first haptic feedback actuator 160 is a linear actuator. The first haptic feedback actuator 160 includes a housing 310, including an external housing 310A and an internal housing 310B, a solenoid 320, the plunger 165, which can include a first portion 165A and a second portion 165B, and a spring 350. FIG. 3A and FIG. 3B differ in that in FIG. 3B, the plunger 165 of the first haptic feedback actuator 160 has linearly translated in response to a magnetic field generated by the solenoid 320. As shown in FIGS. 3A and 3B, the first haptic feedback actuator 160 may be aligned with the opening 220 on the internal surface 250 of the fabric cap 122. Specifically, the plunger 165 of the first haptic feedback actuator 160 is aligned with the opening 220 so that the plunger 165 can make a linear translational movement through the opening 220 to provide a focal impact to a user that is wearing the haptic skull cap 120.

As shown in FIG. 3A, the external housing 310A houses the solenoid 320, internal housing 310B, a portion of the plunger 165, and the spring 350. The housing 310, such as the external housing 310A and internal housing 310B, can be composed of a non-magnetic material such as a plastic or polymer. In various embodiments, the external housing 310A and the internal housing 310B can be a single structure. The internal housing 310B is coupled to an end of the spring 350 through coupling point 340. Furthermore, the opposite end of the spring 350 is coupled to the plunger 165, such as the first portion 165A of the plunger 165.

The solenoid 320 includes multiple electrical coils that encircle the internal housing 310B, a portion of the plunger 165, and a portion of the spring 350. In various embodiments, the solenoid 320 receives a signal from the head mounted display 110 through a wired (e.g., through wire 180A or 180B) or non-wired means. In response to the signal from the head mounted display 110, electron flow through the solenoid 320 generates a magnetic field. The plunger 165 is composed of a ferro-magnetic material and therefore, is actuated in response to the generated magnetic field.

When the first haptic feedback actuator 160 is at rest, as shown in FIG. 3A, the spring 350 is at rest (e.g., not in compression or in tension). When the first haptic feedback actuator 160 receives a signal from the head mounted display 110, the solenoid 320 generates a magnetic field due to the electric current flowing through the solenoid 320. The strength of the magnetic field depends on the electric current flowing through the solenoid. The magnetic field generated by the solenoid 320 causes the plunger 165 to linearly displace to achieve the actuated state as shown in FIG. 3B. Here, at least a portion of the plunger 165 extends through the opening 220 and protrudes from the internal surface 250 of the fabric cap 122.

In the actuated state shown in FIG. 3B, the spring 350 is in compression due to the linear displacement of the plunger 165. The continuous current flow through the solenoid 320 maintains the generated magnetic field and therefore, holds the first haptic feedback actuator 160 in the actuated state. Once the current flow in the solenoid 320 is terminated, the magnetic field generated by the magnetic field collapses. Therefore, the spring 350 returns the plunger 165 to the rest state shown in FIG. 3A.

Referring now to FIG. 4, it depicts an example second haptic feedback actuator 170 of the haptic skull cap 120, in accordance with an embodiment. The second haptic feedback actuator 170 can be embodied as a vibrational motor that provides haptic feedback in the form of vibrations to the user's head. In the embodiment shown in FIG. 4, the second haptic feedback actuator 170 can be an eccentric rotating mass (ERM) vibration motor. Here, the second haptic feedback actuator 170 includes an asymmetric mass 410 that is rotatably coupled through coupling point 430 to the motor 420. In various embodiments, when the ERM vibration motor receives a direct current signal, the motor 420 drives the rotational motion of the asymmetric mass 410. As the asymmetric mass 410 rotates, a centripetal force generated by the rotational motion causes the displacement of the motor 420. The movement of the motor 420 serves as the basis for the vibrational haptic feedback provided to the user. As shown in FIG. 4, the second haptic feedback actuator 170 can be in physical contact with one of the covers 210 depicted in FIG. 2 such that the displacement of the motor 420 is translated through the corresponding cover 210 as vibrational haptic feedback to the user's head.

In various embodiments, the second haptic feedback actuator 170 can be embodied as a different type of vibrational motor. For example, the second haptic feedback actuator 170 can be a linear resonant actuator (LRM) vibrational motor. In these embodiments, the signal provided by the head mounted display 110 to the second haptic feedback actuator 170 is an alternating current that drives the alternating motion of a mass of the LRM motor to generate a vibrational haptic feedback. Thus, the LRM vibrational motor can provide the vibrational haptic feedback through a corresponding cover 210 to the user's head.

### Process of Providing Haptic Feedback Using a Haptic Skull Cap

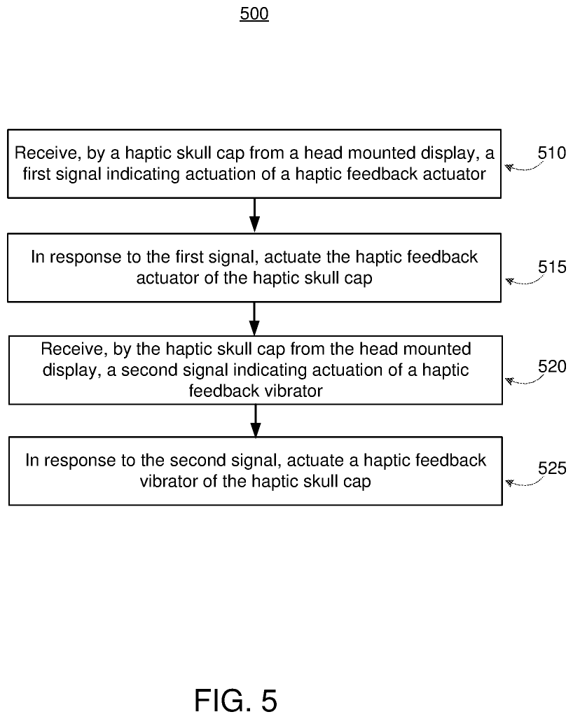

FIG. 5 is a flow process for providing haptic feedback using the haptic skull cap 120, in accordance with an embodiment. The haptic skull cap 120, which is communicatively coupled to a head mounted display 110, receives 510 a first signal for the actuation of a first haptic feedback actuator 160. In various embodiments, the first signal corresponds to a first trigger event in the virtual reality experience that was detected by the head mounted display 110. In response to receiving the first signal, the haptic skull cap 120 actuates 515 the first haptic feedback actuator 160 of the haptic skull cap 120. As one example, the first haptic feedback actuator 160 is a linear actuator. Therefore, the first haptic feedback actuator 160 provides a focal impact as haptic feedback.

The haptic skull cap receives 520 a second signal for the actuation of a second haptic feedback actuator 170, such as a haptic feedback vibrator. In various embodiments, the second signal corresponds to a second trigger event in the virtual reality experience that was detected by the head mounted display 110. The second trigger event can be different from the first trigger event. The haptic skull cap 120 actuates 525 a second haptic feedback actuator 170 of the haptic skull cap 120 in response to the second signal. As an example, the second haptic feedback actuator 170 is a haptic feedback vibrator that provides a vibrational haptic feedback.

While particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

1. A head mounted display system comprising:
a head mounted display; and
a haptic skull cap comprising:
a fabric cap comprising an internal surface, part of which defines an opening;
a haptic feedback actuator physically coupled to a front side of the fabric cap and communicatively coupled to the head mounted display, wherein the haptic feedback actuator is a linear actuator comprising a solenoid and a plunger configured to provide a first type of haptic feedback through the internal surface of the fabric cap in response to a first signal from the head mounted display, the opening of the fabric cap substantially aligned with the plunger to enable a translational movement of the plunger to extend through the opening and protrude from the internal surface of the fabric cap through the opening to provide the first type of haptic feedback; and
a haptic feedback vibrator physically coupled to a left side of the fabric cap and communicatively coupled to the head mounted display, the haptic feedback vibrator configured to provide a second type of haptic feedback through a cover of the internal surface of the fabric cap in response to a second signal from the head mounted display.

2. The head mounted display system of claim 1, wherein the haptic skull cap further comprises a second haptic feedback vibrator physically coupled to the front side of the haptic skull cap and communicatively coupled to the head mounted display, the second haptic feedback vibrator configured to provide the second type of haptic feedback in response to a third signal from the head mounted display.

3. The head mounted display system of claim 1, wherein the haptic skull cap further comprises a third haptic feedback vibrator physically coupled to a rear side of the haptic skull cap, the third haptic feedback vibrator configured to provide the second type of haptic feedback in response to a third signal from the head mounted display.

4. (canceled)

5. (canceled)

6. The head mounted display system of claim 1, wherein the internal surface of the fabric cap comprises a cover through which the haptic feedback vibrator provides the second type of haptic feedback.

7. The head mounted display system of claim 6, the cover sits substantially flush with the internal surface of the fabric cap, and wherein the cover is in physical contact with the haptic feedback vibrator.

8. The head mounted display system of claim 1, wherein the haptic feedback vibrator is an eccentric rotating mass vibration motor.

9. The head mounted display system of claim 1, wherein the haptic feedback vibrator is a linear resonant actuator vibrational motor that provides the second type of haptic feedback.

10. The head mounted display system of claim 1, wherein the fabric cap is composed of a stretchable material selected from one of spandex, elastane, or urethane.

11. The head mounted display system of claim 1, wherein the haptic skull cap is stitched together from two or more fabrics.

12. A haptic skull cap comprising:
a stretchable fabric cap comprising an internal surface, par of which defines an opening;
a haptic feedback actuator physically coupled to a front side of the stretchable fabric cap, wherein the haptic feedback actuator is a linear actuator comprising a solenoid and a plunger substantially aligned with the opening in the internal surface of the fabric cap to enable a translational movement of the plunger to extend through the opening and protrude from the internal surface of the fabric;
a first haptic feedback vibrator physically coupled to a left side of the stretchable fabric cap;
a second haptic feedback vibrator physically coupled to the front side of the stretchable fabric cap; and
a third haptic feedback vibrator physically coupled to a rear side of the stretchable fabric cap.

13. (canceled)

14. The haptic skull cap of claim 12, wherein translational movement of the plunger through the opening provides a first type of haptic feedback.

15. The haptic skull cap of claim 12, wherein the internal surface of the stretchable fabric cap comprises a cover through which the first haptic feedback vibrator provides the second type of haptic feedback.

16. The haptic skull cap of claim 15, the cover sits substantially flush with the internal surface of the stretchable fabric cap, and wherein the cover is in physical contact with the first haptic feedback vibrator.

17. The haptic skull cap of claim 12, wherein the first haptic feedback vibrator is an eccentric rotating mass vibration motor that provides the second type of haptic feedback.

18. The haptic skull cap of claim 12, wherein the first haptic feedback vibrator is a linear resonant actuator vibrational motor that provides the second type of haptic feedback.

19. A method comprising:
receiving, by a haptic feedback actuator comprising a solenoid and a plunger, a first signal indicating actuation of the first haptic feedback actuator, the haptic feedback actuator physically coupled to a fabric cap at an opening substantially aligned with the plunger of the haptic feedback actuator to enable a translational movement of the plunger to extend through the opening and protrude from the internal surface of the fabric cap to provide the first type of haptic feedback;
responsive to receiving the first signal, actuating the haptic feedback actuator to provide a first type of haptic feedback through the fabric cap;
receiving, by a haptic feedback vibrator, a second signal indicating actuation of the haptic feedback vibrator, the haptic feedback vibrator physically coupled to the fabric cap at a second location different from the first location; and
responsive to receiving the second signal, actuating the haptic feedback vibrator to provide a second type of haptic feedback through a cover of an internal surface of the fabric cap.

20. The method of claim 19, wherein the fabric cap is composed of a stretchable material selected from one of spandex, elastane, or urethane.
